(19) United States
(12) Patent Application Publication
(10) Pub. No.: US 2012/0078418 A1
(43) Pub. Date: Mar. 29, 2012

(54) ROBOT CALIBRATION APPARATUS AND METHOD FOR SAME

(76) Inventors: Jin Hwan Borm, Gyeonggi-do (KR); Jung Min Kim, Gyeonggi-do (KR); Sang Wook Park, Gyeonggi-do (KR)

(21) Appl. No.: 13/376,878

(22) PCT Filed: Jun. 3, 2010
(86) PCT No.: PCT/KR2010/003569

§ 371 Date: Dec. 8, 2011

(30) Foreign Application Priority Data
Jun. 8, 2009 (KR) 10-2009-0050518
Jan. 27, 2010 (KR) 10-2010-0007542

(51) Int. Cl. B25J 13/08

(52) U.S. Cl. 700/254

(57) ABSTRACT

A robot calibration apparatus and a robot calibration method. The robot calibration apparatus includes:

a measurement jig including a plurality of reference points of which positions are pre-known, one or more reference lines of which linear equations are pre-known, and one or more reference planes of which plane equations are pre-known relative to a reference coordinate system of the measurement jig, wherein arbitrary points from among the plurality of reference points, the plurality of arbitrary points on the one or more reference line, and the plurality of arbitrary points on the one or more reference plane are set as measurement points;

a sensor coupled to a robot and measuring positions of a plurality of measurement points selected from among the measurement points on the measurement jig;

and a control unit controlling the calibrated robot after calibrating the robot based on a plurality of pieces of calibration data including position information of the plurality of measurement points measured by the sensor, wherein at least one measurement point from among the plurality of measurement points is arranged on the reference line or the reference plane. Accordingly, the robot can be calibrated by using information of measuring an arbitrary position on the reference line or reference plane on the measurement jig, and thus limitation to the measurement posture of the robot can be remarkably reduced while measuring the positions of the measurement points, the position information of the measurement point can be easily obtained, and the robot calibration apparatus can be easily applied to a production line.

### BACKGROUND OF THE INVENTION

1. Field of the Invention

The present invention relates to a robot calibration apparatus and a robot calibration method, and more particularly, to a robot calibration apparatus and a robot calibration method, which calibrate a robot used to perform various accurate operations, such as welding, grinding, cutting, measuring, etc., instead of a person.

2. Description of the Related Art

Robots are widely used in the industrial fields in general, instead of people (to replace human beings or workmen). For example, robots coupled to tools are disposed on a production line to perform various operations to manufacture cars. As such, when the production line is built by coupling various tools to robots, cars may be manufactured in large quantities at a low price. Also, since a robot moves along a designed moving path to perform various operations, the quality (accuracy) of the operations may maintain the same level unlike when the operations are performed by workers. Also, robots are widely used to measure and examine the manufactured parts or products in cooperation with sensors.

Meanwhile, when production lines are automated by the automation devices including robots, the positions/orientations and the operations of the automation devices in the entire production line should be determined before installing the devices.

Here, each robot performs such an operation by inputting a design value to a computer, but it is difficult to build a perfect robot without an error in each design value due to driving errors in various driving devices enabling the robot to operate, a manufacturing error of the robot, and an installation error of a tool. Such an error may be small but is propagated and eventually becomes a big error while actually defining a process, thereby causing a defect in a completed product. Thus a considerable time is required to amend the defect.

In order to prevent such a defect, in a conventional method, positions of a plurality of points (position information is pre-known) on a measurement jig are measured by using a non-contact sensor, such as a laser vision sensor, coupled to the robot, and robot calibration are performed by using the position information of the measured points to minimize the position errors of the tool center point coupled to the robot. Here, calibration is performed to match the position and orientation of robot base, parameters defining kinematic equation of a robot, and an installing position and orientation of a tool.

However, according to a conventional calibration method, only the points set on the measurement jig and of which the position information is known, for example, a center position of a circle, are measured, and thus the measurement postures of the robot are very limited during measuring, and sometimes, measurement may not be possible.

Specifically, when calibration is performed during operation by installing a measurement jig around a robot on a production line, positions of points on the measurement jig are measured during a resting period during operations, and thus a posture of the robot during measurement needs to be flexible.

### SUMMARY OF THE INVENTION

The invention proposes a robot calibration apparatus and a robot calibration method, which easily perform calibration and are easily applicable to a production line by selecting and measuring a plurality of points from among not only a reference point of which position information is pre-known, but also arbitrary points on a reference line of which a linear equation is pre-known and arbitrary points on a reference plane of which a plane equation is pre-known relative to the reference coordinate system of the measurement jig, and performing calibration by using position information of the plurality of measured points. In other words, the invention provides a robot calibration apparatus and a robot calibration method, which use position information of a point measured at any position on a reference line or reference plane on a measurement jig.

According to an aspect of the present invention, there is provided a robot calibration apparatus including: a measurement jig including a plurality of reference points of which position information is pre-known, one or more reference lines of which linear equations are pre-known, and one or more reference planes of which plane equations are pre-known, wherein an arbitrary point from among the plurality of reference points, an arbitrary point on the one or more reference line, and an arbitrary point on the one or more reference plane are set as measurement points; a sensor coupled to a robot and measuring positions of a plurality of measurement points selected from among the measurement points on the measurement jig; and a control unit controlling the robot by calibrating the robot based on a plurality of pieces of calibration data including position information of the plurality of measurement points measured by the sensor, wherein at least one measurement point from among the plurality of measurement points is arranged on the reference line or the reference plane.

According to another aspect of the present invention, there is provided a robot calibration method including: arranging a plurality of reference points of which position information is pre-known, one or more reference lines of which linear equations are pre-known, and one or more reference planes of which plane equations are pre-known around a robot; selecting a plurality of measurement points from among an arbitrary point from among the plurality of reference points, an arbitrary point on the one or more reference lines, and an arbitrary point on the one or more reference planes, such that at least one measurement point from among the plurality of measurement points is arranged on the reference line or reference plane; obtaining position information of the plurality of measurement points by measuring positions of the plurality of selected measurement points by using a sensor coupled to the robot; and calibrating the robot based on a plurality of pieces of calibration data including the position information of the plurality of measurement points.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram of a robot calibration apparatus according to an embodiment of the present invention;

FIG. 2 is a block diagram for describing operations of the robot calibration apparatus of FIG. 1; and

FIG. 3 is a flowchart schematically illustrating a robot calibration method according to an embodiment of the present invention.

### DETAILED DESCRIPTION OF THE INVENTION

Hereinafter, the present invention will be described more fully with reference to the accompanying drawings, in which exemplary embodiments of the invention are shown.

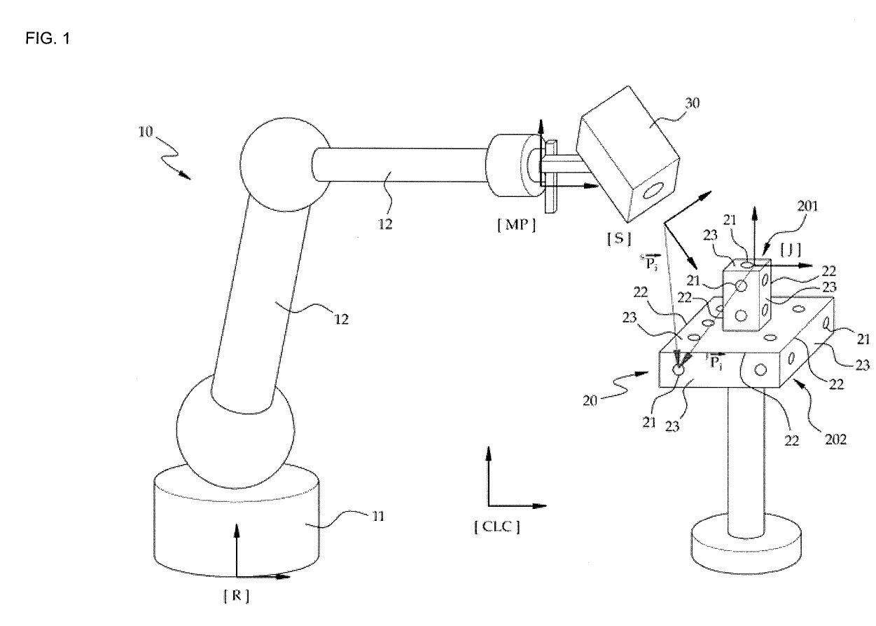

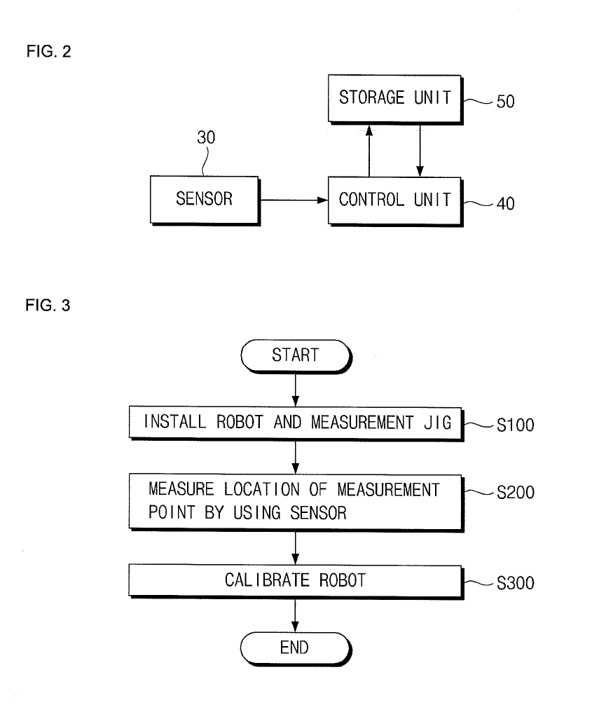

FIG. 1 is a schematic diagram of a robot calibration apparatus according to an embodiment of the present invention, and FIG. 2 is a block diagram for describing operations of the robot calibration apparatus of FIG. 1.

Referring to FIGS. 1 and 2, the robot calibration apparatus according to the current embodiment is used to precisely predict various parameters controlling kinematic equations, such as a position and orientation of a base 11 of a robot 10, a parameter controlling a robot kinematic equation, and a position and orientation of installing a tool (not shown). When parameters precisely predicted are used while controlling the robot 10 to move to an arbitrary position, a position and orientation of a tool reference coordinate system or a position of a tool center point viewed from a user coordinate system or robot reference coordinate system may be calculated closer to the reality, and thus the tool center point may be accurately arranged on a desired position. As a result, when the robot calibration apparatus is effectively realized, the robot 10 may be more precisely controlled such that the tool center point is precisely moved to a position desired by a user.

The robot 10 includes the base 11 and a plurality of links 12 coupled to the base 11, and specifically in the current embodiment, the robot 10 includes two links 12. Also, various coordinate systems as follows are set for the robot 10, a measurement jig 20, and a sensor 30.

[R]: Base coordinate system of robot 10

[MP]: Coordinate system of fingertip of robot 10

[J]: Reference coordinate system of measurement jig 20

[S]: Reference coordinate system of sensor 30, wherein position information of measured measurement point is obtained based on coordinate system [S]

[CLC]: Reference coordinate system of object (not shown) to be processed, such as a car

^{S}\vec{R}ᵢ: Measurement point on measurement jig 20 or object to be processed, which is measured by sensor 30.

^{J}\vec{P}ᵢ: Reference point on measurement jig 20 viewed from coordinate system [J]

The robot calibration apparatus includes the measurement jig 20, the sensor 30, and a control unit 40.

The measurement jig 20 is formed of a material of which deformation due to environmental changes, such as temperature and humidity, is minimized, and includes a pair of measurement jig portions 201 and 202 each having rectangular parallelepiped shapes. The measurement jig 20 includes a plurality of reference points, a plurality of reference lines 22, and a plurality of reference planes 23, which are to be measured by the sensor 30. The reference point is a point as described above in the related art, and is a center of a circle 21. Also, position information of the reference point, i.e., the position information on the reference coordinate system [J] of the measurement jig 20, i.e., an x-axis value, a y-axis value, and a z-axis value are all known. The reference line 22 is set at the corner of each of the measurement jig portions 201 and 202, and the reference plane 23 is set as a surface of each of the measurement jig portions 201 and 202. A linear equation and a plane equation respectively of the reference line 22 and the reference plane 23 are pre-known on the reference coordinate system [J] of the measurement jig 20.

Then, the reference points, an arbitrary point on the reference line 22, and an arbitrary point on the reference plane 23 are each set as measurement points of which positions are measured by the sensor 30. As such, the measurement jig 20 includes 3 types of measurement points having different properties, i.e., the reference point, the measurement point set on the reference line 22, and the measurement point set on the reference plane 23. The position information of the reference point on the measurement jig 20, linear equation of the reference line 22, and plane equation of the reference plane 23 is accurately pre-measured by a measuring device, such as a laser tracker.

Also, according to the current embodiment, the reference line 22 on the measurement jig 20 is parallel to at least one of an x-axis, a y-axis, and a z-axis of the reference coordinate system [J] set on the measurement jig 20, and the reference plane 23 on the measurement jig 20 is perpendicular to at least one of the x-axis, the y-axis, and the z-axis of the reference coordinate system [J] set on the measurement jig 20.

Meanwhile, when the robot 10, the measurement jig 20, and the sensor 30 are configured as shown in FIG. 1, the reference coordinate system [J] of the measurement jig 20 and the reference coordinate system [S] of the sensor 30 may be modeled to a relationship represented by Equation 1 below.

$${}_{ }^{J}{T}{}_{S}^{} = {}_{}^{J}{T}{}_{CLC}^{} {}_{}^{CLC}{T}{}_{R}^{} {{}^{R} F ( x )}_{MP} {}_{}^{MP}{T}{}_{S}^{} \\ {}_{}^{J}{\vec{P}}{}_{i}^{} = {}_{}^{J}{T}{}_{S}^{} {}_{}^{S}{\vec{P}}{}_{i}^{} \\ [ \begin{matrix}{}_{ }^{J}{Px}{}_{i}^{} \\ {}_{ }^{J}{Py}{}_{i}^{} \\ {}_{ }^{J}{Pz}{}_{i}^{} \\ 1\end{matrix} ] = {}_{ }^{J}{T}{}_{S}^{} [ \begin{matrix}{}_{ }^{S}{Px}{}_{i}^{} \\ {}_{ }^{S}{Py}{}_{i}^{} \\ {}_{ }^{S}{Pz}{}_{i}^{} \\ 1\end{matrix} ] \\ {}_{}^{J}{T}{}_{S}^{} = {}_{}^{J}{T}{}_{CLC}^{} \cdot {}_{}^{CLC}{T}{}_{R}^{} \cdot {}^{R} F ( x ) \cdot {}_{}^{MP}{T}{}_{S}^{} \qquad [ Equation 1 ]$$

Here, F(x)=F(\vec{θ}, \vec{t}) denotes forward kinematics of the robot 10, \vec{Θ} denotes a robot joint angle vector, and \vec{t} denotes various parameter vectors to be predicted. Also, ^{J}\vec{P}ᵢ denotes a vector from the reference point viewed from the reference coordinate system [J] of the measurement jig 20 to the arbitrary point on the reference line 22 and to the arbitrary point on the reference plane 23. In the reference point, 3 positions ^{J}Px, ^{J}Py, and ^{J}Pz on the reference coordinate system [J] of the measurement jig 20 are all known, but in the arbitrary point on the reference line 22, one linear equation, i.e., only two independent position relationships are known, and in the arbitrary point on the reference plane 23, one plane equation, i.e., only one position relationship is known. Also, ^{S}\vec{P}ᵢ denotes a vector from the sensor 30 to the measurement point. Here, as described above, the measurement point is the reference point, the arbitrary point on the reference line 22, or the arbitrary point on the reference plane 23.

Here, if the measurement point is the reference point, Equation 1 is satisfied since the position of the reference point, i.e., ^{J}Px, ^{J}Py, and ^{J}Pz are all known. Also, 3 equations are obtained whenever the reference point, for example, the center of the circle 21, on the measurement jig 20 is measured. Also, since the reference coordinate system of the measurement jig 20 is perpendicular or parallel to the reference line 22 and the reference plane 23 on the measurement jig 20 as described above, only two values from among ^{J}Px, ^{J}Py, and ^{J}Pz of Equation 1 are determined when the arbitrary point on the reference line 22 is measured as the measurement point, and thus two equations are obtained whenever the arbitrary point on the reference line 22 is measured. Also, when the arbitrary point on the reference plane 23 is measured, only one value from among ^{J}Px, ^{J}Py, and ^{J}Pz is determined, and thus one equation is obtained whenever the arbitrary point on the reference plane 23 is measured.

The parameter \vec{t} satisfying all of the plurality of equations prepared as above is obtained by using an optimization technique.

As a result, 3 equations are obtained by measuring the reference point, 2 equations are obtained by measuring the arbitrary point on the reference line 22, and 1 equation is obtained by measuring the arbitrary point on the reference plane 23.

Meanwhile, according to the current embodiment, the reference line 22 on the measurement jig 20 is perpendicular or parallel to the reference coordinate system [J] of the measurement jig 20, and the reference plane 23 on the measurement jig 20 is also perpendicular or parallel to the reference coordinate system [J] of the measurement jig 20, but the same result as described above may be obtained by using a following method even when the reference line 22 and the reference plane 23 are not perpendicular or parallel to the reference coordinate system [J].

If the measurement point exists on the reference line 22 or the reference plane 23 that is not parallel or perpendicular to the reference coordinate system [J] of the measurement jig 20, a new coordinate system, i.e., the ordinary reference coordinate system [H], which is parallel or perpendicular to the reference coordinate system [J], is set on the measurement jig 20 as follows to apply the above-described method. Hereinafter, a reference line and a reference plane that are not parallel or perpendicular to the reference coordinate system [J] will now be respectively referred to as a arbitrary reference line and an arbitrary reference plane.

A direction vector of a reference line not parallel or perpendicular to the reference coordinate system [J] may be represented as follows.

^{J}\vec{n}=(^{J}nₓ,^{J}n_{y},^{J}n_{z})^{T}

Also, a normal vector of a reference plane not parallel or perpendicular to the reference coordinate system [J] may be represented as follows.

^{J}\vec{n}=(^{J}nₓ, ^{J}n_{y}, ^{J}n_{z})^{T}

As such, when the ordinary reference coordinate system [H], to which an arbitrary reference line or arbitrary reference plane expressed on the reference coordinate system [J] is perpendicular or parallel, is found and a correlation between the reference coordinate system [J] and the ordinary coordinate system [H] is found, the arbitrary reference line or arbitrary reference plane on the reference coordinate system [J] may be perpendicular or parallel to the ordinary coordinate system [H].

If ^{J}\vec{n}=(^{J}nₓ,^{J}n_{y},^{J}n_{z})^{T} denotes the direction vector of the arbitrary reference line or the normal vector of the ordinary reference plane, ^{J}T^{H} parallel to the z-axis of the ordinary coordinate system [H] may be easily obtained by obtaining α and β satisfying Equation 2 below. Here, the ordinary coordinate system [H] is prepared when the reference coordinate system [J] rotates by an angle α in the direction of x-axis and by an angle β in the direction of y-axis. In other words, α and β denote rotation amount from the reference coordinate system [J] to the ordinary coordinate system [H].

^{J}T_{H}=Rotx(α)Roty(β)=[?? ?? ^{J}\vec{n}] [Equation 2]

Here, Rotx(α) denotes a rotation matrix rotating by the angle α in the direction of x-axis, and Roty(β) denotes a rotation matrix rotating by the angle β in the direction of y-axis. Also, ?? denotes an unknown value (the same is applied for following equations).

Meanwhile, the arbitrary reference line in the reference coordinate system [J] is also parallel to any one of the x-axis, the y-axis, and the z-axis of the ordinary reference coordinate system [H]. As a result, when an arbitrary point on the arbitrary reference line is measured in the ordinary reference coordinate system [H], only two values from among ^{H}Px, ^{H}Py, and ^{H}Pz are known, and thus two equations may be obtained whenever the arbitrary point on the arbitrary reference line is measured.

For example, if the arbitrary reference line is parallel to the z-axis of the ordinary reference coordinate system [H] and the measurement point exists on the arbitrary reference line, the measurement point is located on the arbitrary reference line, and only x and y values are known from position information of the measurement point in the ordinary reference coordinate system [H]. Accordingly, Equation 1 is changed to Equation 3 below.

$$[ \begin{matrix}{}_{}^{H}{Px}{}_{i}^{} \\ {}_{}^{H}{Py}{}_{i}^{} \\ ?? \\ 1\end{matrix} ] = {}_{}^{H}{T}{}_{J}^{} {}_{}^{J}{T}{}_{S}^{} [ \begin{matrix}{}_{}^{S}{Px}{}_{i}^{} \\ {}_{}^{S}{Py}{}_{i}^{} \\ {}_{}^{S}{Pz}{}_{i}^{} \\ 1\end{matrix} ] \qquad [ Equation 3 ]$$

2 Equations are obtained from the arbitrary reference line based on the Equation 3.

Also, the arbitrary reference plane on the reference coordinate system [J] is perpendicular to any one of the x-axis, the y-axis, and the z-axis of the ordinary reference coordinate system [H]. As a result, when the arbitrary point on the arbitrary reference plane is measured from the ordinary reference coordinate system [H], only one value from among ^{H}Px, ^{H}Py, and ^{H}Pz is known, and thus one equation may be obtained whenever the arbitrary point on the arbitrary reference plane is measured.

For example, when the arbitrary reference plane is parallel to the z-axis of the ordinary reference coordinate system [H] and the measurement point exists on the arbitrary reference plane, the measurement point is located on the arbitrary reference plane and only z value is known from position information of the measurement point on the ordinary reference coordinate system [H]. Accordingly, Equation 1 is changed to Equation 4 below.

$$[ \begin{matrix}?? \\ ?? \\ {}_{}^{H}{Pz}{}_{i}^{} \\ 1\end{matrix} ] = {}_{}^{H}{T}{}_{J}^{} {}_{}^{J}{T}{}_{S}^{} [ \begin{matrix}{}_{}^{S}{Px}{}_{i}^{} \\ {}_{}^{S}{Py}{}_{i}^{} \\ {}_{}^{S}{Pz}{}_{i}^{} \\ 1\end{matrix} ] \qquad [ Equation 4 ]$$

1 equation is obtained from the arbitrary reference plane based on Equation 4.

Meanwhile, the sensor 30 included in the robot calibration apparatus is coupled to the robot 10. The sensor 30 is a non-contact sensor, such as a laser vision sensor, and measures positions of the plurality of measurement points selected from among the reference points on the measurement jig 20, the arbitrary point on the reference line 22, and the arbitrary point on the reference plane 23 to obtain calibration data. Here, at least one of the selected measurement points is on the reference line 22 or the reference plane 23, and the calibration data includes the position information of the measured measurement points. In addition, the calibration data includes various pieces of information, such as a position and direction of a robot joint. Also, since the number of pieces of the calibration data is pre-set according to calibration, the number of measured measurement points is selected according to the number of pieces of the calibration data. Also, the position information of the measurement point measured by the sensor 30 is stored in a storage unit 50.

The control unit 40 calibrates the robot 10 via a well known data processing operation, such as a least-squares method by using the calibration data. When the robot 10 is calibrated as such, parameter values more precisely predicted can be used while moving the robot 10 to an arbitrary position, and thus the robot 10 may be precisely controlled. For example, when the robot 10 is used for measurement, a camera is installed to the robot 10, and a camera reference coordinate system of the camera may be precisely controlled by using calibration results, thereby minimizing a position error of an original point of the camera reference coordinate system. Also, a motor is controlled by precisely calculating a rotation amount of the motor so as to reduce the position error of the original point of the camera reference coordinate system. Accordingly, a position error of the tool center point may be reduced.

Also, the control unit 40 performs a control operation by being electrically connected to the storage unit 50 and the sensor 30. In other words, the control unit 40 stores the position information of the measurement point measured by the sensor 30 in the storage unit 50, and if calculation needs to be performed by the control unit 40, the position information of the measurement point stored in the storage unit 50 is read.

A robot calibration method using the robot calibration apparatus described above will now be described with reference to FIG. 3. Here, it is assumed that a welding gun (not shown) is coupled to the robot 10 so that the robot 10 is installed to a production line of, for example, cars, to perform a welding operation.

First, the measurement jig 20 is installed around the robot 10. Here, one measurement jig 20 may be installed around the robot 10, or in some cases, a plurality of measurement jigs 20 may be installed around the robot 10, in operation S100.

Then, the position of the measurement point is measured by using the sensor 30, in operation S200, during a resting period between welding operations or before the welding operation is initially performed. Here, the measurement point is the reference point, the arbitrary point on the reference line 22, or the arbitrary point on the reference plane 23.

As such, the measuring of the position of reference point is performed a plurality of times to obtain a minimum equation suitable for calibration. Then, the robot 10 is calibrated in operation S300 by using the obtained equation. When the calibration is completed, a position error of the tip of the welding gun may be reduced.

As described above, since 3 measurement points having different properties, i.e., not only the reference point (center of the circle 21) on the measurement jig 20 but also the arbitrary point on the reference line 22 and the arbitrary point on the reference plane 23, are used to calibrate a certain point of the robot 10, i.e., the position of tool center point, unlike a conventional technology, a posture of the robot 10 while measuring the measurement point on the measurement jig 20 is not limited. In other words, the posture of the robot 10 is much less limited when the point on the reference line 22 is measured than when the center of the circle 21 on the measurement jig 20 is measured, and moreover, the posture of the robot 10 is much less limited when the point on the reference plane 23 is measured than when the center of the circle 21 or the point on the reference line 22 is measured. Accordingly, the measurement point on the measurement jig 20 may be immediately and easily measured without a limit to the posture of the robot 10.

Specifically, a resting period when the robot 10 stands by without performing an operation is generally short, and by using the robot calibration apparatus and the robot calibration method of the embodiments, the measurement point can be quickly measured so as to measure the measurement point and calibrate the robot 10 by using the measured position information during such a short resting period. This is because as described above, not only the reference point (center of the circle 21), but also the arbitrary point on the reference line 22 and the arbitrary point on the reference plane 23 are set as the measurement points, and thus the posture of the robot 10 is much less limited when a point on a reference line or on a reference plane than when a reference point is measured.

According to the present invention, since position information of any position on a reference line or reference plane on a measurement jig can be used during calibration, position information of a point used for calibration can be easily obtained without a limit to a posture of a robot.

Also, since position information of a measurement point for calibration can be easily measured and obtained during a resting period between operations, a robot calibration apparatus and a robot calibration method of the present invention can be easily applied to an actual production line.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A robot calibration apparatus comprising:
a measurement jig comprising a plurality of reference points of which position information is pre-known, one or more reference lines of which linear equations are pre-known, and one or more reference planes of which plane equations are pre-known relative to a reference coordinate system of the measurement jig, wherein arbitrary points from among the plurality of reference points, arbitrary points on the one or more reference line, and arbitrary points on the one or more reference plane are set as measurement points;
a sensor coupled to a robot and measuring positions of a plurality of measurement points selected from among the measurement points on the measurement jig; and
a control unit controlling the calibrated robot after calibrating the robot based on a plurality of pieces of calibration data comprising position information of the plurality of measurement points measured by the sensor,
wherein at least one measurement point from among the plurality of measurement points is arranged on the reference line or the reference plane.

2. The robot calibration apparatus of claim 1, wherein the reference line is parallel to any one of an x-axis, a y-axis, and a z-axis on the reference coordinate system of the measurement jig, and
the reference plane is perpendicular to any one of the x-axis, the y-axis, and the z-axis on the reference coordinate system of the measurement jig.

3. The robot calibration apparatus of claim 1, wherein at least one reference line from among the one or more reference lines is an arbitrary reference line not parallel to any of an x-axis, a y-axis, and a z-axis on the reference coordinate system of the measurement jig,
at least one reference plane from among the one or more reference lines is an arbitrary reference plane not perpendicular to any of the x-axis, the y-axis, and the z-axis on the reference coordinate system of the measurement jig, and
the control unit calculates a correlation between the reference coordinate system and a coordinate system in which the arbitrary reference line is parallel to any one of an x-axis, a y-axis, and a z-axis and the arbitrary reference plane is perpendicular to any one of the x-axis, the y-axis, and the z-axis, and uses the calculated correlation to calibrate the robot.

4. A robot calibration method comprising:
arranging a plurality of reference points of which position information is pre-known, one or more reference lines of which linear equations are pre-known, and one or more reference planes of which plane equations are pre-known relative to a reference coordinate system of the measurement jig;
selecting a plurality of measurement points from among the plurality of reference points, a plurality of measurement points from on the one or more reference lines, and a plurality of measurement points from on the one or more reference planes, such that at least one measurement point from among the plurality of measurement points is arranged on the reference line or reference plane;
measuring positions of the plurality of selected measurement points by using a sensor coupled to the robot; and
calibrating the robot based on a plurality of pieces of calibration data comprising the position information of the plurality of measurement points.

5. The robot calibration method of claim 4, wherein the measurement jig comprises the reference points, the reference lines, and the reference plane;
the reference line is parallel to any one of an x-axis, a y-axis, and a z-axis of the reference coordinate system of the measurement jig, and
the reference plane is perpendicular to any one of the x-axis, the y-axis, and the z-axis of the reference coordinate system of the measurement jig.

6. The robot calibration method of claim 4, wherein the measurement jig comprises the reference point, the reference line, and the reference plane,
at least one reference line from among the one or more reference lines is an arbitrary reference line not parallel to any of an x-axis, a y-axis, and a z-axis of the reference coordinate system of the measurement jig,
at least one reference plane from among the one or more reference planes is an arbitrary reference plane not perpendicular to any of the x-axis, the y-axis, and the z-axis of the reference coordinate system of the measurement jig, and
the robot calibration method further comprises calculating a correlation between the reference coordinate system and a coordinate system in which the reference line is parallel to any one of an x-axis, a y-axis, and a z-axis and the reference plane is perpendicular to any one of the x-axis, the y-axis, and the z-axis, and uses the calculated correlation to calibrate the robot.
